(19) United States
(12) Patent Application Publication
(10) Pub. No.: US 2007/0169309 A1
(43) Pub. Date: Jul. 26, 2007

(54) Spring hinge for spectacles

(75) Inventor: Harald Buchegger, St. Konrad (AT)

Correspondence Address: WILLIAM COLLARD;COLLARD & ROE, P.C., 1077 NORTHERN BOULEVARD, ROSLYN, NY, 11576, US

(73) Assignee: REDTENBACHER PRAZISIONSTEILE GES. M.B.H., A 4644 SCHARNSTEIN AUSTRIA (AU)

(21) Appl. No.: 10/589,026

(22) PCT Filed: May 17, 2005
(86) PCT No.: PCT/AT05/00167

§ 371 Date: Aug. 10, 2006

(30) Foreign Application Priority Data
May 14, 2004 (AT) A 851/2204

(51) Int. Cl. G02C 5/22

(52) U.S. Cl. 16/228

(57) ABSTRACT

A spring hinge for spectacles is described, comprising a hinge part (3) which is held in a displaceable manner in the longitudinal direction of the temple in a housing (4) on the temple side, a fixture (6) which projects from the hinge part (3) in the direction of displacement, engages in an opening (5) in the housing and comprises a fixture rod (7) and a transversal bar (8) at the end of the fixture rod (7), and two helical springs (10) which are provided laterally adjacent to the fixture rod (7), are parallel thereto and rest with their end at the hinge side on an abutment associated with the housing and with their opposite end on the transversal bar (8) of the fixture (6). In order to enable the insertion of the hinge part (3) and the helical springs (10) after the fastening of the housing (4) to the temple it is proposed that the two helical springs (10) are inserted into a housing bore (9) each which is open towards the housing opening (5) for the fixture rod (7), and that the housing bores (9) each receive a locking element (11) forming the abutment for the helical spring.

### FIELD OF THE INVENTION

The invention relates to a spring hinge for spectacles, comprising a hinge part which is held in a displaceable manner in the longitudinal direction of the temple in a housing on the temple side, a fixture which projects from the hinge part in the direction of displacement, engages in an opening in the housing and comprises a fixture rod and a transversal bar at the end of the fixture rod, and two helical springs which are provided laterally adjacent to the fixture rod, are parallel thereto and rest with their end at the hinge side on an abutment associated with the housing and with their opposite end on the transversal bar of the fixture.

### DESCRIPTION OF THE PRIOR ART

In order to achieve a shorter overall length in the case of spring hinges for spectacles without having to omit sufficient spring force in the case of a predetermined spring travel, it is known two provide two parallel helical springs in a housing joined to the temple, which springs rests on the hinge side on the housing and on the opposite side on a fixture which is connected with the hinge part which is displaceably held in the housing, so that the hinge part can be withdrawn from the housing only against the restoring force of the parallel helical springs in a manner delimited by a stop. The fixture can consist of a fixture rod with a transversal bar at the end side, on which rest helical springs arranged on both sides of the fixture rod (WO 97/041482 A1). Another possibility (WO 97/45764 A1) is to form the fixture with a stop for the two helical springs which projects against the temple, which springs are situated on the temple-side of the fixture directly adjacent to one another. Since in both embodiments the housing comprises an opening open towards the temple, into which the fixture of the hinge part is inserted with the two helical springs transversally to the direction of displacement of the hinge part, the hinge part with the fixture and the two helical springs must be inserted into the housing before the housing is joined to the temple by welding or soldering. This comes with the disadvantage that not only the housing but also the fixture with the two helical springs are subjected to a respective thermal stress during welding or soldering. Moreover, after the fastening of the housing to the temple it is possible to exchange neither the hinge part with the fixture nor the helical screws.

### SUMMARY OF THE INVENTION

The invention is thus based on the object of providing a spring hinge for spectacles of the kind mentioned above in such a way that an insertion of the hinge part with the fixture and the two helical springs is enabled after the fastening of the housing to the temple.

This object is achieved by the invention in such a way that the two helical springs are inserted into a housing bore each which is open towards the housing opening for the fixture rod and that the housing bores each receive locking element forming the abutment for the helical spring.

Since as a result of these measures the two housing bores for receiving the helical springs are open towards the housing opening for the fixture rod, the transversal bar of the fixture engages at the end of the fixture rod radially into the housing bores for the helical springs, so that the hinge part with the fixture can also be inserted from the face side of the housing on the hinge side in the axial direction into the housing opening before the helical springs are inserted into the housing bores. The housing bores receiving the helical springs merely need to be sealed by locking elements in order to complete the mounting of the hinge spring. The locking elements form the abutments on the housing side for the helical springs which place the hinge part via the fixture under a respective pretension within the terms of withdrawal into the housing. All constructional preconditions are fulfilled with the insertion both of the hinge part as well as the helical springs in the axial direction from the face side of the housing in order to enable the insertion of the hinge part With the helical springs into the housing after the fastening of the housing to the temple. The arrangement of the helical springs on either side of the fixture ensures access to the housing bores for the helical springs even after the insertion of the hinge part.

Although the locking elements forming the abutments for the helical springs can be fixed in different ways axially with respect to the housing bores, especially simple constructional conditions are obtained when the locking elements are screwed into the housing bores. The screwed joint allows a simple detachment of the locking elements and thus an exchange of the hinge part or the helical springs, if required.

### BRIEF DESCRIPTION OF THE DRAWINGS

The subject matter of the invention is shown by way of example in the drawings, wherein:

FIG. 1 shows a spring hinge in accordance with the invention for spectacles in a longitudinal section view parallel to the hinge axis;

FIG. 2 shows a sectional view along line II-II of FIG. 1,

FIG. 3 shows a sectional view along line III-III of FIG. 1, and

FIG. 4 shows a cross-sectional view through the spring hinge according to line IV-IV of FIG. 1 on an enlarged scale.

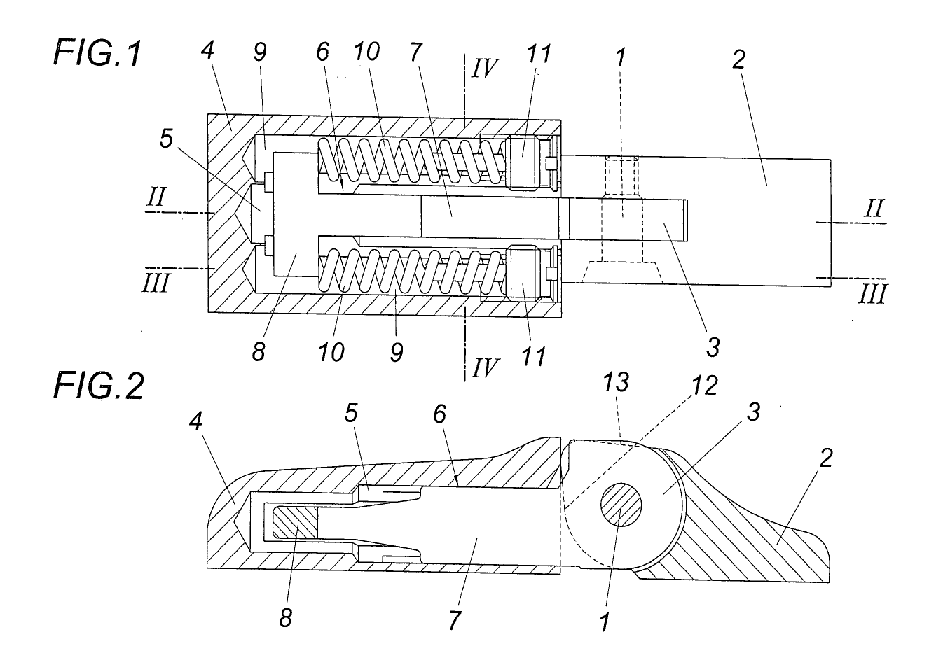

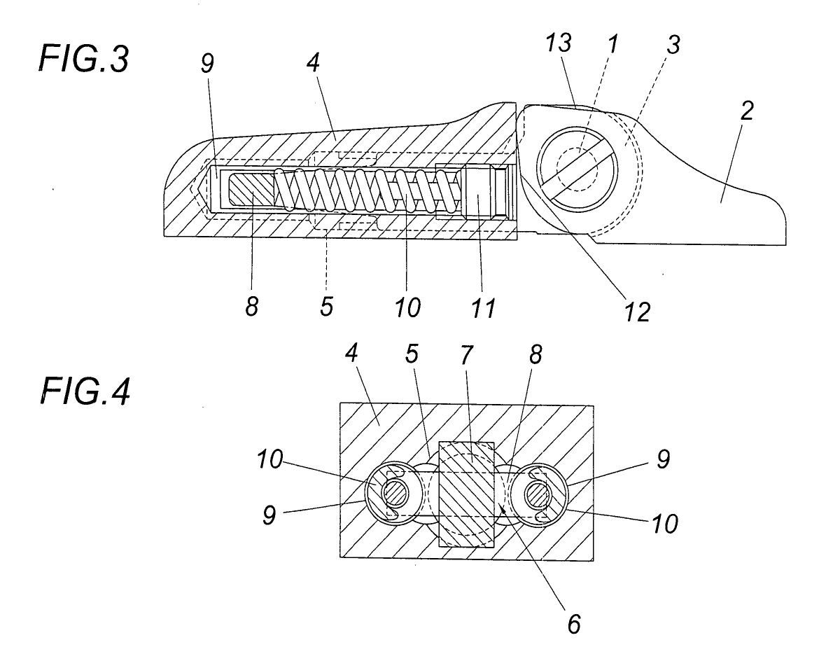

### DESCRIPTION OF THE PREFERRED EMBODIMENTS

The spring hinge according to the illustrated embodiment comprises two hinge parts 2 and 3 which are joined by a hinge shaft 1, of which the hinge part 2 is joined to a temple cheek, whereas the hinge part 3 is held in a displaceable manner in a housing 4 fastened to a temple. For this purpose, the hinge part 3 which forms a middle hinge tab with a bearing eye for the hinge shaft 1 is connected with a fixture 6 engaging in a housing opening 5, which fixture comprises a fixture rod 7 with a transverse bar 8, which rod is displaceable in the housing opening 5, but is protected against twisting. A housing bore 9 each is provided on either side of the housing opening 5, which bore is open towards the housing opening 5 in order to provide a radial pass-through for the transversal bar 8. As a result of the pass-through opening between the housing opening 5 and the two housing bores 9 which extend up to the face side of the housing 4 on the hinge side, the hinge part 3 can be slid axially from the face side of the housing 4 with the fixture 6 into the housing 4 before helical screws 10 can be inserted into the threaded bores 9 for pressurizing the hinge part 3. For the purpose of axially locking the helical springs 10, the housing bores 9 are sealed on the hinge side with the help of locking elements 11 which are screwed according to the embodiment into a threaded section on the end side of the housing bores 9 and form an abutment for the helical springs 10 which are thus clamped under a respective pretension between the transversal bar 8 of the fixture 6 and the locking elements 11. This means that the hinge part 3 is pulled by the helical springs 10 over the fixture 6 in a resilient manner against the housing 4, with the hinge part 2 being pressed with one of two stop surfaces 12, 13 against the face side of the housing 4 depending on the position of the temple in order to secure via the stop surface 12 the stretched used position or via the stop surface 13 the swiveled-in idle position of the temple.

1: A spring hinge for spectacles, comprising a hinge part which is held in a displaceable manner in the longitudinal direction of the temple in a housing on the temple side, a fixture which projects from the hinge part in the direction of displacement, engages in an opening in the housing and comprises a fixture rod and a transversal bar at the end of the fixture rod, and two helical springs which are provided laterally adjacent to the fixture rod, are parallel thereto and rest with their end at the hinge side on an abutment associated with the housing and with their opposite end on the transversal bar of the fixture, wherein the two helical springs (10) are inserted into a housing bore (9) each which is open towards the housing opening (5) for the fixture rod (7), and that the housing bores (9) each receive a locking element (11) forming the abutment for the helical spring.

2: A spring hinge according to claim 1, wherein the locking elements (11) are screwed into the housing bores (9).
